(19) United States
(12) Patent Application Publication
(10) Pub. No.: US 2026/0362361 A1
(43) Pub. Date: Nov. 12, 2026

(54) TRACEABILITY FOR LAYERED INTENT FRAMEWORK ARCHITECTURE

(71) Applicant: InterDigital Patent Holdings, Inc., Wilmington, DE (US)

(72) Inventors: Michel Roy, Candiac (CA); Kevin Di Lallo, Laval (CA); Catalina Mladin, Hatboro, PA (US); Ulises Olvera-Hernandez, Saint-Lazare (CA); Taimoor Abbas, Sainte-Julie (CA)

(73) Assignee: InterDigital Patent Holdings, Inc., Wilmington, DE (US)

(21) Appl. No.: 19/202,830

(22) Filed: May 8, 2025

(51) Int. Cl. H04W 60/04; H04L 41/16; H04L 41/5067; H04W 8/22

(52) U.S. Cl. CPC H04W 60/04; H04L 41/16; H04L 41/5067; H04W 8/22

(57) ABSTRACT

A method is used by a network node having intent management function (IMF) capability. The method comprises receiving a first message which is a request to activate an intent and comprises intent information. The method comprises determining a list of actions based on the intent information from the first message, assigning an intent instance identification to the intent, initiating a lifecycle fo the intent, sending a second message to register the intent, and receiving a third message indicating registration of the intent. The third message comprises a traceability correlation identifier. The method comprises associating the intent instance identification with the traceability correlation identifier, and sending a fourth message, based on the determined list of action. The fourth message may include the traceability correlation identifier. The intent information may comprise at least one of: an intent identifier, an intent semantic description, intent configuration parameters, intent management parameters, or intent requestor information.

### BACKGROUND

Intent-based networking (IBN) is a network management approach that considers consumer and operator objectives rather than traditional network configuration requirements. These objectives are known as intents. An intent describes a desired outcome, as opposed to a traditional approach where the focus is on the means of achieving a desired outcome.

### SUMMARY

A method may be used by a network node having intent management function (IMF) capability. The method may comprise receiving a first message. The first message may be a request to activate an intent. The first message may comprise intent information. The method may comprise determining a list of actions based on the intent information from the first message. The determining a list of action based on the intent information from the first message may be based on artificial intelligence/machine learning (AI/ML). The method may comprise assigning an intent instance identification to the intent. The method may comprise initiating a lifecycle for the intent. The method may comprise sending a second message to register the intent. The method may comprise receiving a third message indicating registration of the intent. The third message may comprise a traceability correlation identifier. The method may comprise associating the intent instance identification with the traceability correlation identifier. The method may comprise sending a fourth message, based on the determined list of action. The fourth message may include the traceability correlation identifier.

The intent information may comprise at least one of: an intent identifier, an intent semantic description, intent configuration parameters, intent management parameters, or intent requestor information. The intent management parameters may include information regarding an intent lifecycle. The requestor information may comprise an intent requestor identification and requestor security credentials. The first message may be received from an intent consumer, wherein the intent consumer may be at least one of: a wireless transmit/receive unit (WTRU), a network function (NF), or an application function (AF); wherein the second message is sent to a unified data management (function) (UDM)/unified data registry (UDR); wherein the third message is received from the UDM/UDR; and wherein the fourth message is sent to the intent consumer. The list of actions may comprise actions for realizing an objective of the intent. The second message may comprise at least one of: an IMF identifier, the assigned intent instance identification, the intent information, or intent requestor information.

The method may comprise receiving a message associated with the intent. The message associated with the intent may comprise at least one of: an indication that an action associated with the intent is complete, an indication that an event associated with the intent has been detected, or an indication of a quality of experience (QoE) associated with the intent. The QoE is used to correlate a user experience with the lifecycle of the intent

The method may comprise sending a message to update the intent. The message to update the intent may comprise at least one of: the traceability correlation identifier, the intent instance identification, a completed action, an event detection, or a quality of experience (QoE). The method may comprise receiving a message indicating that the intent is updated. The method may comprise sending a message indicating that the intent is updated comprising at least the traceability correlation identifier and the intent instance identification.

The method may comprise receiving a message requesting a traceability report associated with the intent comprising the traceability correlation identifier, the intent instance identification, and report filters. The method may comprise sending a message requesting retrieval of the traceability report comprising the traceability correlation identifier, the intent instance identification, and report filters. The method may comprise receiving a traceability report. The method may comprise sending the traceability report.

A network node may have intent management function (IMF) capability. The network node may comprise a receiver, a transmitter, and a processor. The receiver may be configured to receive a first message. The first message may be a request to activate an intent. The first message may comprise intent information. The processor may be configured to determine a list of actions based on the intent information from the first message. The processor may be configured to initiate a lifecycle for the intent. The determined list of action based on the intent information from the first message is based on artificial intelligence/machine learning (AI/ML). The processor may be further configured to assign an intent instance identification to the intent. The transmitter may be configured to send a second message to register the intent. The receiver may be further configured to receive a third message indicating registration of the intent. The third message may comprise a traceability correlation identifier. The processor may be further configured to associate the intent instance identification with the traceability correlation identifier. The transmitter may be further configured to send a fourth message, based on the determined list of action. The fourth message may include the traceability correlation identifier.

The intent information may comprise at least one of: an intent identifier, an intent semantic description, intent configuration parameters, intent management parameters, or intent requestor information. The intent management parameters may include information regarding an intent lifecycle. The requestor information may comprise an intent requestor identification and requestor security credentials. 14. The network node of claim 11, wherein the first message is received from an intent consumer, wherein the intent consumer is at least one of: a wireless transmit/receive unit (WTRU), a network function (NF), or an application function (AF); wherein the second message is sent to a unified data management (function) (UDM) / unified data registry (UDR); wherein the third message is received from the UDM/UDR; and wherein the fourth message is sent to the intent consumer. The list of actions may comprise actions for realizing an objective of the intent. The second message may comprise at least one of: an IMF identifier, the assigned intent instance identification, the intent information, or intent requestor information.

The receiver may be further configured to receive a message associated with the intent. The message associated with the intent may comprise at least one of: an indication that an action associated with the intent is complete, an indication that an event associated with the intent has been detected, or an indication of a quality of experience (QoE) associated with the intent. The QoE is used to correlate a user experience with the lifecycle of the intent

The transmitter may be further configured to send a message to update the intent. The message to update the intent may comprise at least one of: the traceability correlation identifier, the intent instance identification, a completed action, an event detection, or a quality of experience (QoE). The receiver may be further configured to receive a message indicating that the intent is update. The transmitter may be further configured to send a message indicating that the intent is updated comprising at least the traceability correlation identifier and the intent instance identification.

The receiver may be further configured to receive a message requesting a traceability report associated with the intent comprising the traceability correlation identifier, the intent instance identification, and report filters. The transmitter may be further configured to send a message requesting retrieval of the traceability report comprising the traceability correlation identifier, the intent instance identification, and report filters. The receiver may be further configured to receive a traceability report. The transmitter may be further configured to send the traceability report.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example procedure for registering an active intent to enable traceability;

FIG. 3 shows an example procedure for layered intent activation traceability including two layers of intent activation;

FIG. 4 shows an example procedure for layered intent activation traceability including three layers of intent activation and additional application programming interface (API) calls;

FIG. 5 shows an example procedure for layered intent events traceability;

FIG. 6 shows an example procedure for layered intent quality of experience (QoE) traceability;

FIG. 7 shows an example procedure for layered intent traceability reporting;

FIG. 8 shows an example procedure for enabling traceability for a layered intent framework architecture by a network node with Intent Management Function (IMF) capabilities; and

FIG. 9 shows an example procedure for enabling traceability for a layered intent framework architecture by a UDM/UDR.

### DETAILED DESCRIPTION

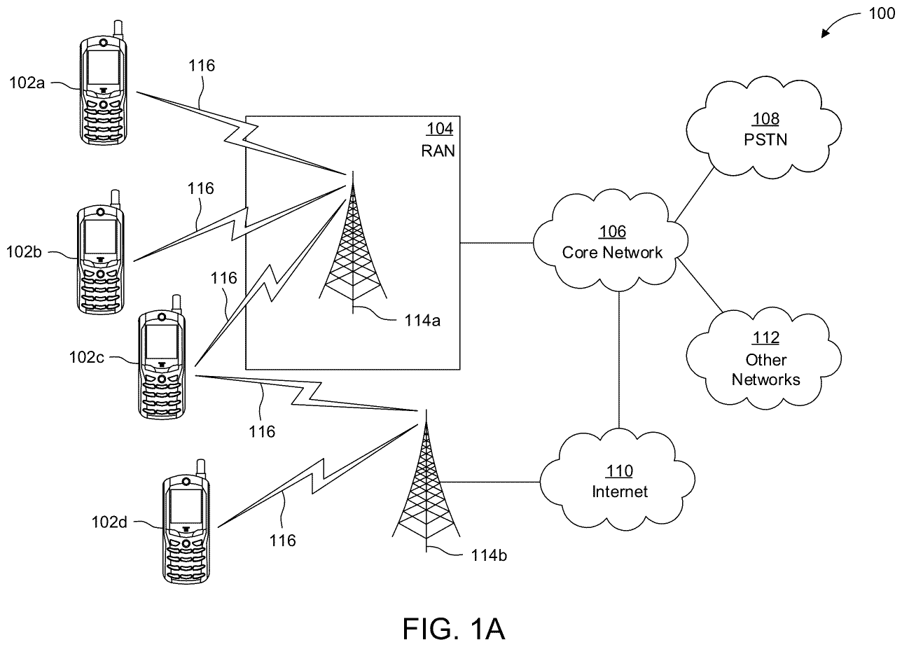

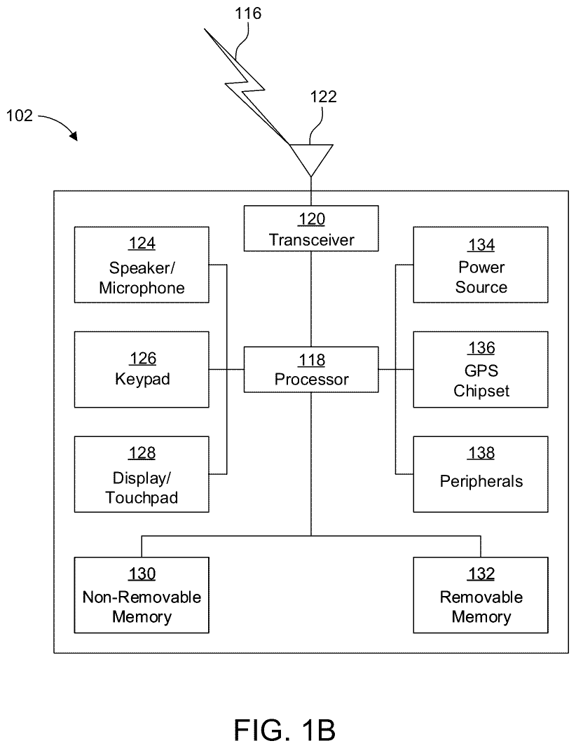

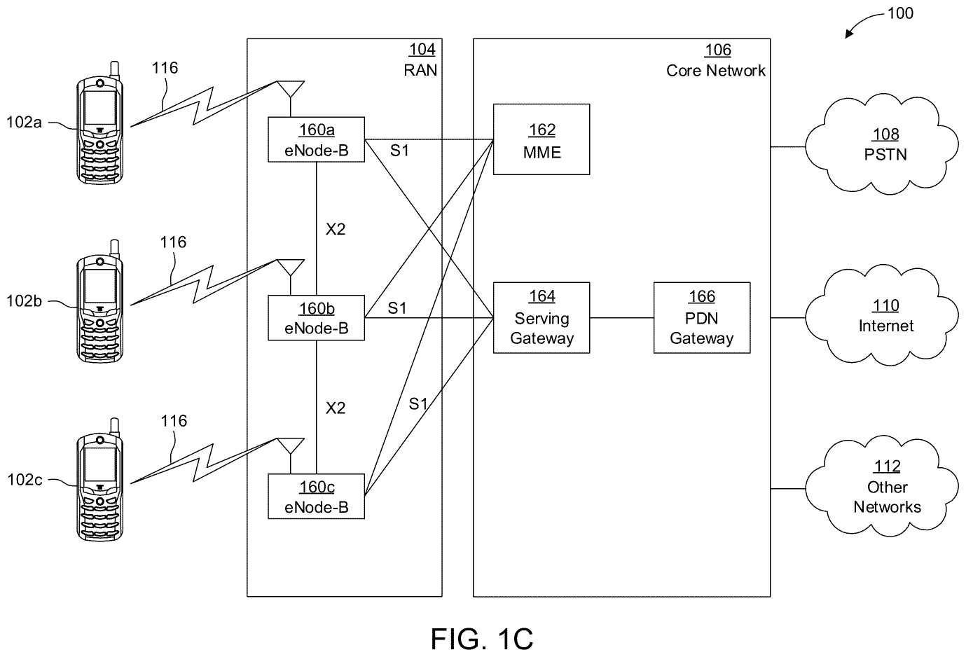

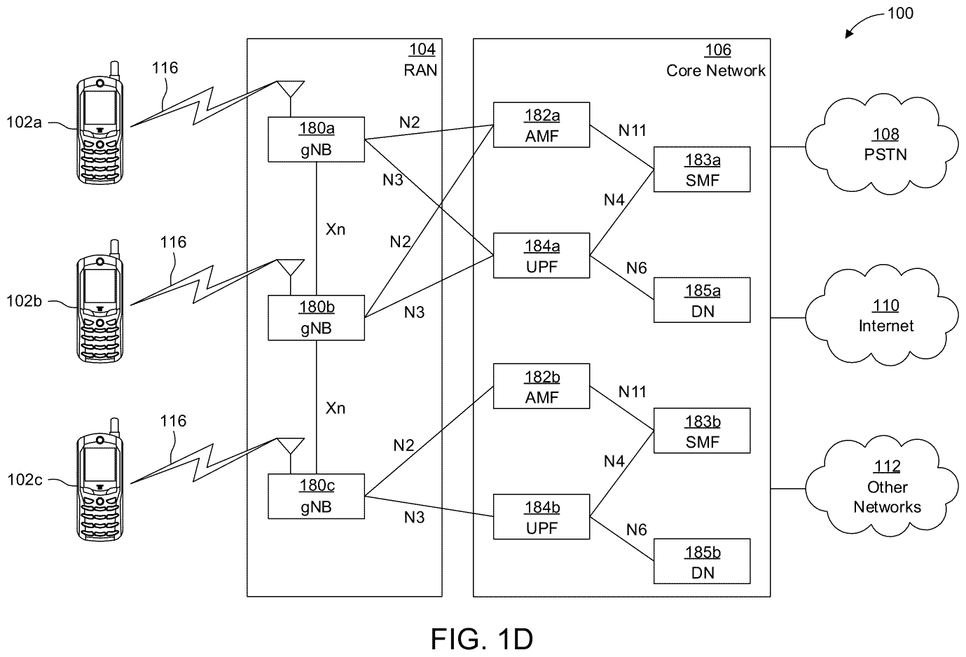

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An intent-based networking (IBN) network may obtain intents from network consumers and/or operators and translate the intents into one or more lists of actions and/or policies that may be applied to the network. The IBN network may have pre-defined list of actions and/or policies that are associated with intents for achieving both consumer and network operator objectives. The IBN network may use artificial intelligence/machine learning (AI/ML) systems to generate an optimal list of actions and/or policies for achieving both consumer and network operator objectives.

The IBN network may activate an intent by performing a list of actions and/or a policy. This intent activation results in configuring the network to operate in a way that meets the consumer and network operator objectives.

The IBN network may monitor network operation to ensure that the network is behaving as intended. The IBN network may use analytics services and/or traditional network and device application programming interfaces (APIs) to obtain the information required to evaluate network performance.

The main benefits of IBN for users include simplified network interactions and interoperability across networks, and the main benefits for network operators include network deployment flexibility and operational predictability.

3GPP systems support a service-based architecture with service-based interfaces (SBI) for core network functions, application enablers and the management system. These SBI correspond to APIs that specify information elements that may be configured by an API consumer. An API consumer must be aware of the supported information elements and their impact on the network in order to efficiently use the API. The responsibility of achieving an objective is assigned to the API consumer and it is assumed that the API consumer knows how to use the network APIs and knows how to combine the network APIs together to achieve an objective. In other words, the network is agnostic about the API consumer objective and simply executes the API calls made by an API consumer independently.

Intent-based service exposure relies on intents to expose functionality. Intents allow an API consumer to convey a desired objective or outcome rather than combining a sequence of API calls with hopes of attaining the objective. The intent exposure framework may interpret an intent and transform the intent objective into a list of actions and/or policy that is specific for a given network. This abstracts the network inner workings from the API consumer and allows the API provider to configure the network optimally.

In other words, intent-based service exposure attempts to configure the network considering both the consumer's objectives and network operator's objectives, as opposed to the traditional network exposure that only considers the consumer's objective by specifying values for well-defined API parameters.

Current 3GPP systems are beginning to support intent-based service exposure. For example, the 3GPP management system supports intent driven management services for mobile networks.

An autonomous network is a network that may operate without or with limited human intervention. An autonomous network may configure, monitor, and maintain itself independently, typically with the aid of AI/ML systems. Such systems may collect and analyze data from the network and make dynamic operational decisions to optimize network efficiency, adaptability and quality of service.

Current 3GPP systems have begun adopting technologies that may enable autonomous network deployments by introducing data collection and analytics services, and by enabling AI/ML services. Next generation networks are expected to continue this trend by offering unified and simplified APIs and by adding support for intent-based networking.

Traceability in a mobile network refers to the capability of tracking, identifying and logging the behavior and interactions of WTRUs, network functions (NFs) or application functions (AFs) across the network, including cross-layers and external interactions.

A trace session may be activated via the management system or via the unified data management (function) (UDM)/unified data registry (UDR) and is typically enabled for a target WTRU, gNB or NF instance.

Upon activation of a trace session, network functions such as the access and mobility management function (AMF), session management function (SMF), user plane function (UPF), and gNB may be triggered to collect trace data. It may be appreciated that each of these entities must independently implement and support the trace activation and generation API.

While the existing traceability framework allows collecting traces at different functional entities, it may be appreciated that such framework does not allow collecting traces that are associated specifically with a given intent or objective.

In other words, the existing traceability granularity is limited to functional entities (e.g., WTRU level, gNB level, NF level) and the traces collected will be all traces associated with that functional entity. The traceability granularity cannot be adjusted based only a precise/single WTRU objective such as “start an XR session with a minimum QoS of X at the edge”.

Network exposure refers to exposing network capabilities, information or events to systems, application, or users in a controlled and secure manner. Network exposure often happens through well-defined APIs or interfaces that may be standardized. Network exposure includes exposing information to external entities and exposing information across internal network subsystems.

Wireless network architecture, such as the architecture for a 3GPP network, is organized in different sub-systems also referred to as layers or domains. For example, the 3GPP system architecture includes the Radio Access Network (RAN) subsystem, the Core Network (CN) subsystem, the application enablement subsystem, edge hosting environment subsystem, or the management subsystem. Network sub-systems are isolated by design for security, privacy, and functional reasons. These subsystems require exposure to each other to enable cross-system interactions and functionality. Additional isolation and/or fragmentation between sub-systems occurs based on business relationships and interworking capabilities. The term subsystem and system may be used interchangeably herein.

The usage of subsystems exposure available in the mobile network is further complicated by the multiplicity, the complexity and the variety of APIs that are independently defined on a per subsystem basis.

As such, the existent framework assumes that the API consumer is knowledgeable about network exposure and network deployments when interacting with the network. For example, it is expected that the API consumer can determine which API needs to be invoked to realize an objective, can determine how to discover and interact with these APIs in an ordered and secure manner and can interpret correctly and logically the information obtained from these APIs. Mobile network operators (MNOs) do not consistently support the same capabilities and deployments which further complicates the adoption of network exposure for API consumers.

To remedy these complications, it is envisioned that a unified network exposure framework will be adopted in future network evolution to facilitate the API consumer adoption, and further that an intent-based exposure framework may be considered to move the network capabilities and deployment specificities on the network side.

The adoption of such unified and intent based exposure framework in the layered network presents challenges.

A first challenge is associated with the transfer of responsibility to the network to fulfill the user objectives (e.g., the intent's objective). With traditional exposure, individual API calls are made by a user and therefore the system only requires collecting traceability information based on API call of the user, the system is agnostic about the objective of the user, and different API calls may be logged independently. With intent-based exposure, the responsibility of fulfilling an objective is transferred to the network; as such, this may simplify and improve controllability of interactions and traceability of all API calls associated with an intent may become essential. Thus, a solution for end-to-end traceability of an active intent in a layered network is required.

A second challenge is associated or related to the traceability associated with an active intent lifecycle. An intent may be active for a short or a prolonged period. For example, an intent to retrieve information may be active for a brief period and terminate once the information is returned. Alternatively, an intent may be associated with a session that may be active for multiple hours. It then becomes necessary to define traceability system that can track the lifecycle of an intent regardless of the intent lifecycle.

A third challenge is associated with the Quality of Experience (QoE) aspects experienced by a user. With traditional exposure, the responsibility of fulfilling QoE objectives is with the user and when bad QoE is experienced, it is up to the user to interact with the network to correct the situation. With intent-based exposure, the responsibility of fulfilling the user objective is transferred to the network, thus it becomes critical that a user may express the experienced QoE towards an active intent. It is therefore essential that the QoE inputs from the user is considered in an active intent traceability.

Thus, it is plausible that the network evolves towards an intent-based exposure framework, that such framework requires new traceability capabilities for external and cross-layers exposure and require new traceability capabilities for capturing traceability information per active intent, for various intent lifecycle durations considering events and/or QoE fluctuations.

The existing traceability framework defined in the mobile network does not support such capabilities.

Embodiment to enable traceability for a layered intent framework are discussed including: defining information elements for use in the embodiments described herein; defining a procedure for registering an active intent for traceability; exemplary embodiments showing traceability scenarios for an intent activation across a layered network architecture; an exemplary embodiment showing traceability for events associated with an active intent; an exemplary embodiment showing QoE reporting with an active intent; and defining a procedure for enabling active intent traceability reporting.

Deployment considerations for the Intent Management Function (IMF) and the intent functionality of the UDM/UDR are described herein.

The IMF may be implemented and deployed as a standalone service (e.g., a NF or AF) within a network or that the functionality provided by the IMF may be implemented in an existing functional entity by extending the capabilities of the network entity in the network.

The intent functionality of the UDM/UDR described herein may be implemented and deployed as a standalone service (e.g., a NF or AF), for example in a dedicated traceability information storage service different than the UDM/UDR. The intent functionality of the UDM/UDR may include functionality for registering an active intent, for updating an active intent or for reporting about an active intent and may be implemented as part of the UDM/UDR as described herein.

In an embodiment, traceability may be enabled for a layered intent framework architecture, including a combination of traceability across network layers of a MNO, traceability across MNOs, traceability for intent related events, traceability for user experienced QoE and methods for enabling traceability reporting.

A network node with IMF capabilities (e.g., IMF anchor) may perform one or more of the following actions.

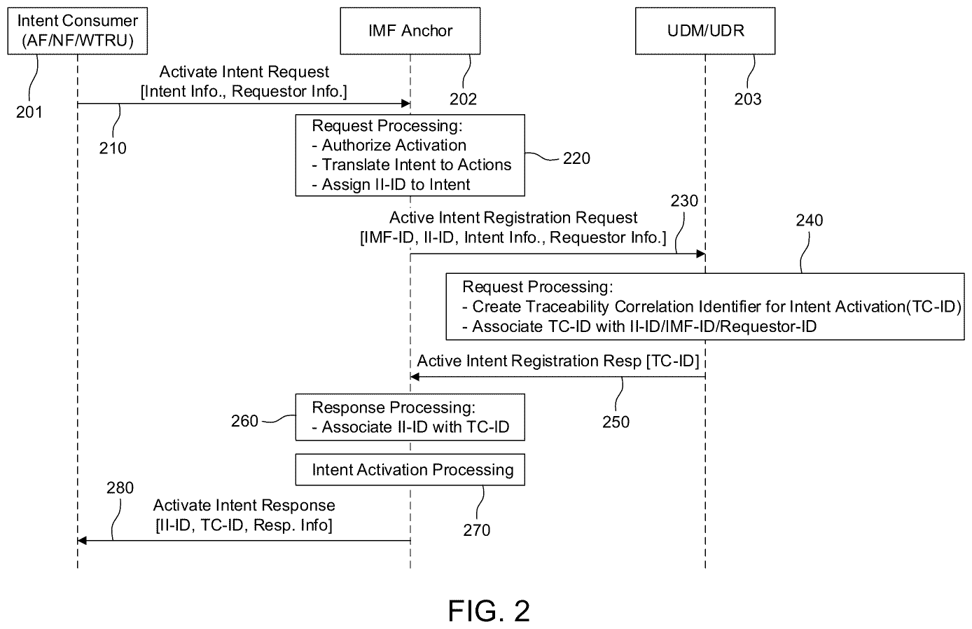

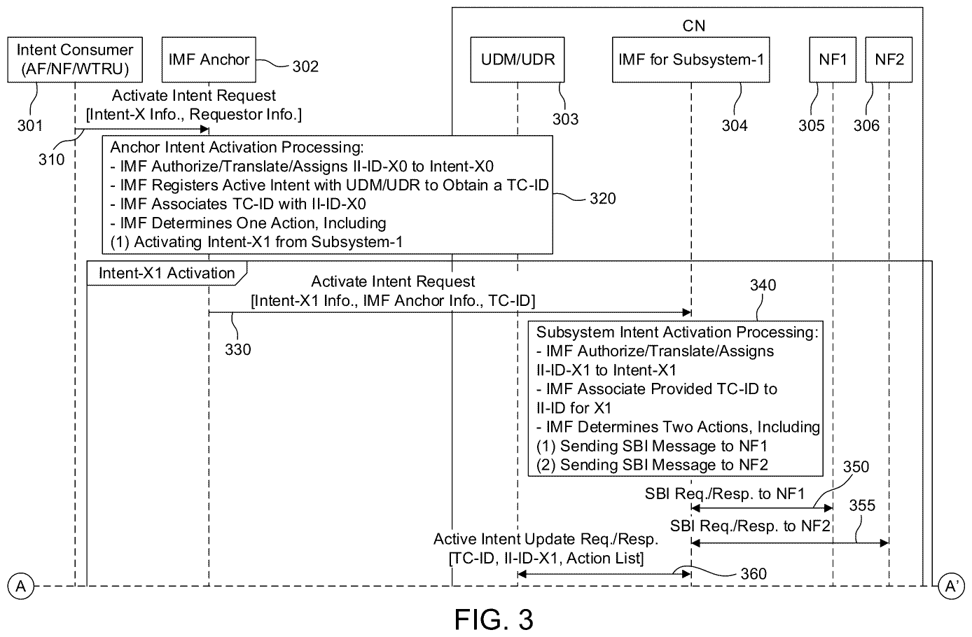

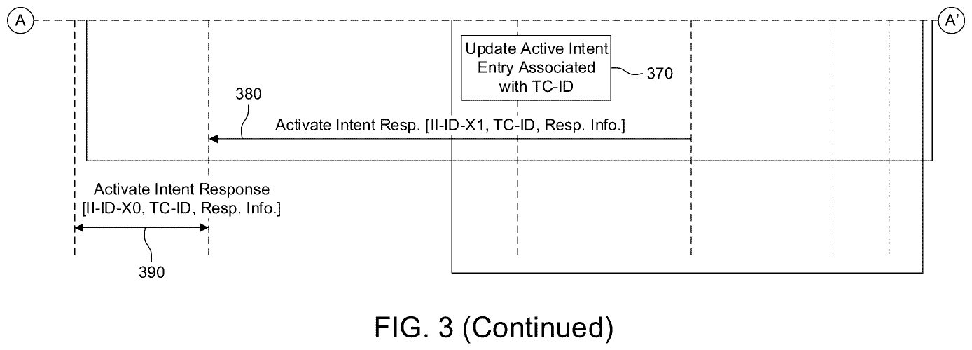

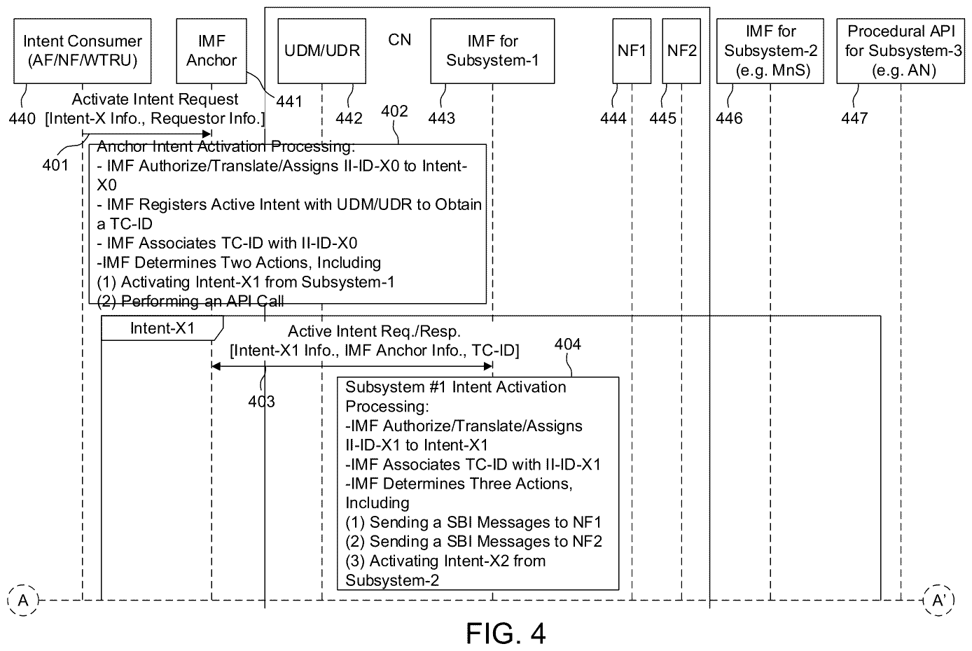

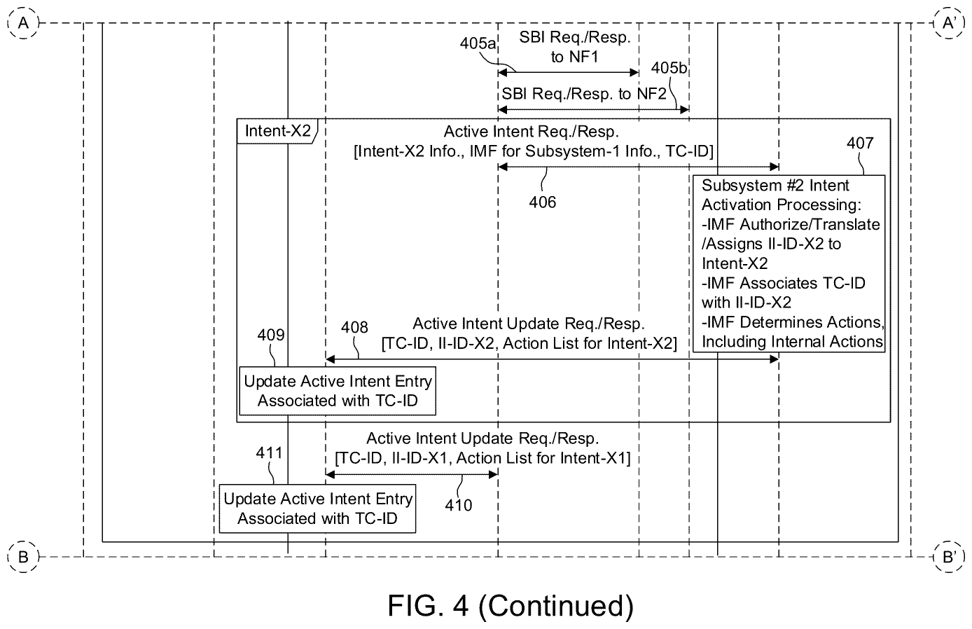

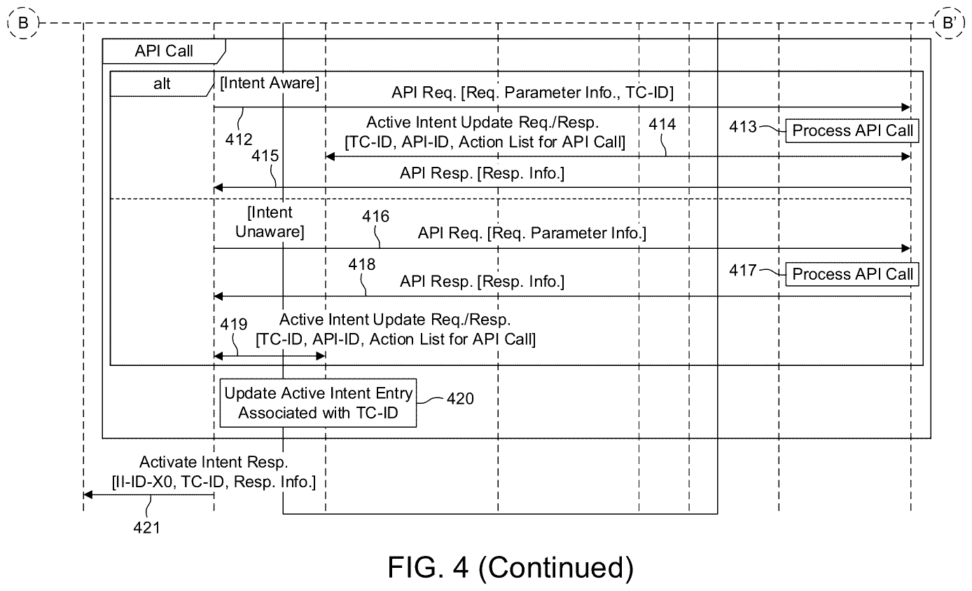

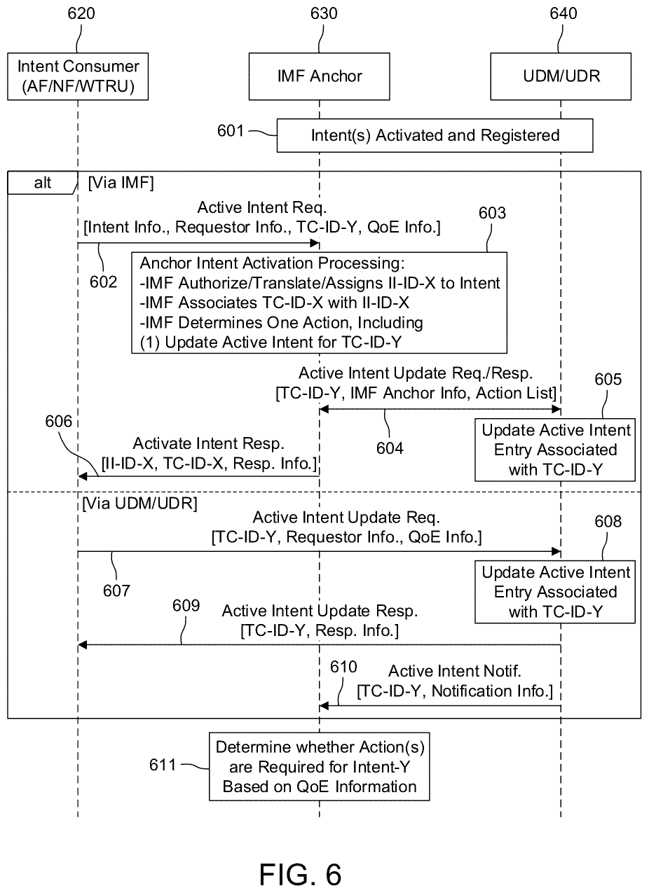

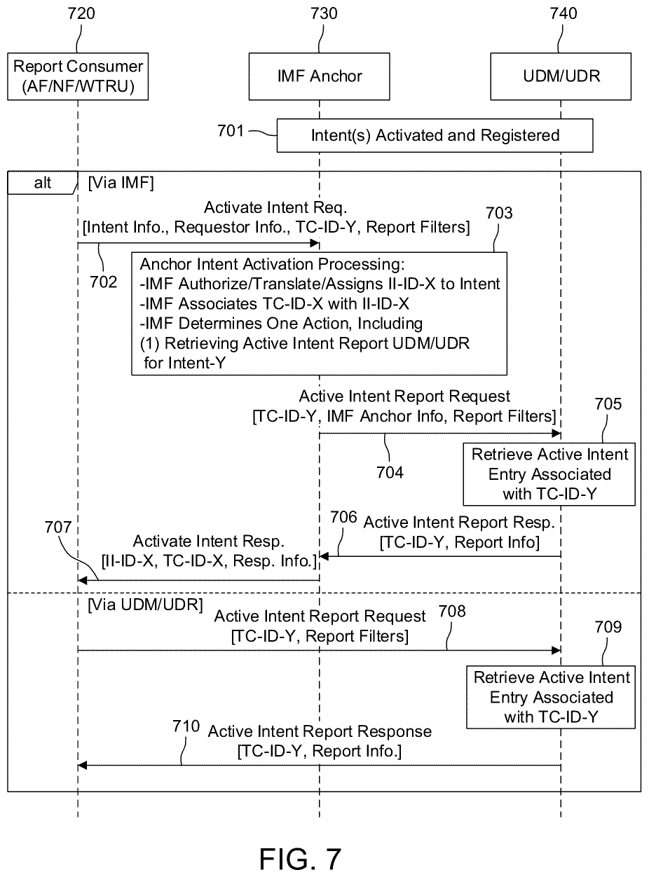

The network node may receive a message to activate an intent (e.g., an intent activation message). For example as shown in 210 of FIGS. 2, 310 of FIGS. 3, 401 of FIGS. 4, 602 of FIGS. 6 and 702 of FIG. 7. The message may include intent information and requestor information. The message may be received from an intent consumer (e.g., WTRU/NF/AF).

The network node may process the intent activation message. For example, as shown in 220 of FIGS. 2, 320 and 340 of FIG. 3, and 402, 404, 407 of FIGS. 4, 603 of FIGS. 6 and 703 of FIG. 7. The network node may authorize the message processing. The network node may translate the message information into a list of actions (e.g., active intent). The network node may assign or associate an identifier to the active intent to identify an intent instance (e.g., Intent Instance Identifier (II-ID)). The network node may maintain an association between one or more actions from a list of actions, requests, one or more related II-ID and one or more associated events.

The network node may send a message (e.g., request message) to register an active intent for traceability. For example as shown in 230 of FIGS. 2, 320 of FIG. 3, and 402 of FIG. 4. The message may include an IMF identifier, the assigned II-ID, the intent information, and/or the intent requestor information. The request message may be sent to a UDM/UDR.

The network node may receive a message indicating a registration of the active intent for traceability (e. g, a registration indication message). For example as shown in 250 of FIGS. 2, 320 of FIG. 3, and 402 of FIG. 4. The message may include an identifier that uniquely identifies a root active intent and that may be used by the UDM/UDR to provide traceability on subsystem intents and/or API invocations that may have been triggered by the root active intent across network subsystems (e.g., a Traceability Correlation Identifier (TC-ID)).

The network node may process the registration indication message. For example as shown in 260 of FIGS. 2, 320 FIG. 3, and 402 of FIG. 4. The network node may associate the II-ID with the TC-ID.

The network node may send one or more messages based on the determined list of actions. For example as shown in 270 of FIGS. 2, 330, 350 and 355 of FIGS. 3, 403, 405a, 405b, 406, 412, and 416 of FIGS. 4 and 604 of FIG. 6. The one or more messages may include the TC-ID. The one or more messages may be sent to at least one of an IMF, a NF, an API or a subsystem.

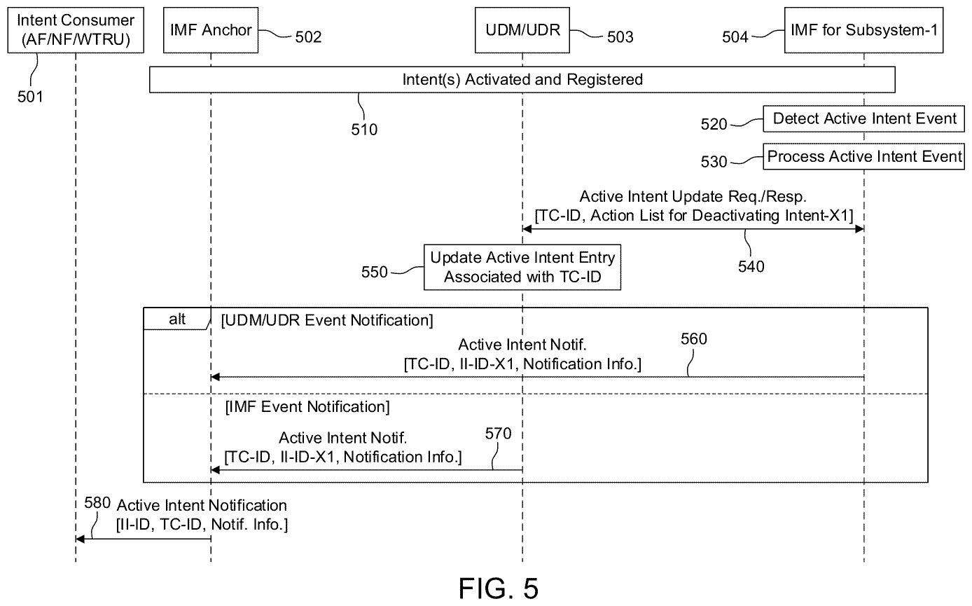

The network node may receive one or more messages associated with an active intent. For example as shown in 270 of FIGS. 2, 350, 355, and 380 of FIG. 3, and 403, 405a, 405b, 406, 415, and 418 of FIGS. 4, 560 and 570 of FIGS. 5 and 604 and 610 of FIG. 6. The one or more messages may include an indication that an action associated with an active intent has been completed. The one or more messages may include an indication that an event associated with an active intent has been detected. The one or more messages may include an indication of a QoE associated with an active intent. The one or more messages may be received from at least one of a WTRU, an IMF, a UDM/UDR, an NF or a subsystem.

The network node may send a message to update an active intent. For example as shown in 360 of FIGS. 3, 408, 410, and 419 of FIGS. 4, 540 of FIG. 5, and 604 of FIG. 6. The message may include a TC-ID, an II-ID, and one or more of: a completed action, an event detection or a QoE. The message may be sent to a UDM/UDR.

The network node may send a message to indicate that an active intent has been activated. For example as shown in 280 of FIGS. 2, 380 and 390 of FIGS. 3, 403, 406 and 421 of FIGS. 4, 580 of FIGS. 5, 606 of FIGS. 6 and 707 of FIG. 7. The message may include a TC-ID, an II-ID, an indication that an intent has been activated and may include information related to the completion of an intent. The message may be sent to at least one of an intent consumer (e.g., WTRU, IMF, NF, AF).

The network node may receive a message to retrieve a traceability report associated with an active intent. For example as shown in 702 of FIG. 7. The message may include a TC-ID and/or II-ID and report filters. The message may be received from a report consumer (e.g., WTRU, NF, AF).

The network node may send a message to retrieve a traceability report. For example as shown in 704 of FIG. 7. The message may include a TC-ID and report filters. The message may be sent to a UDM/UDR.

The network node may receive a message indicating a traceability report. For example as shown in 706 of FIG. 7. The message may include a traceability report associated with a TC-ID. The message may be received from an UDM/UDR.

The network node may send a message indicating a traceability report. For example as shown in 707 of FIG. 7. The message may include a traceability report associated with an active intent. The message may be sent to a report consumer (e.g., WTRU/NF/AF).

In an embodiment, a UDM/UDR may perform one or more of the following actions.

The UDM/UDR may receive a message to register an active intent (e.g., active intent registration request). For example as shown in 230 of FIGS. 2, 320 of FIG. 3, and 402 of FIG. 4. The message may include an IMF identifier (IMF-ID), an Intent Instance identifier (II-ID), information about an intent and information about an intent requestor. The message may be received from an IMF (e.g., network node with IMF capabilities).

The UDM/UDR may process the active intent registration. For example as shown in 240 of FIGS. 2, 320 of FIG. 3, and 402 of FIG. 4. The UDM/UDR may authorize the message processing. The UDM/UDR may assign a Traceability Correlation Identifier (TC-ID) to the active intent. The UDM/UDR may create a traceability entry for the active intent traceability.

The UDM/UDR may send a message indicating a registered active intent. For example as shown in 250 of FIGS. 2, 320 of FIG. 3, and 402 of FIG. 4. The message may include an indication of an active intent and a TC-ID. The message may be sent to an IMF.

The UDM/UDR may receive a message to update an active intent (e.g., active intent update). For example as shown in 360 of FIGS. 3, 408, 410, 414, and 419 of FIGS. 4, 540 of FIG. 5, and 604 and 607 of FIG. 6. The message may include a TC-ID, an Intent Instance Identifier (II-ID) and an action list. The message may be received from at least one of: an IMF, a WTRU, an NF, an AF or a subsystem and may be received via a network exposure function (NEF).

The UDM/UDR may process the active intent update. For example as shown in 370 of FIGS. 3, 409, 411, and 420 of FIGS. 4, 550 of FIG. 5, and 605 and 608 of FIG. 6. The UDM/UDR may update the active intent associated with a TC-ID with traceability information

The UDM/UDR may receive a message to retrieve a traceability report. For example as shown in 704 and 708 of FIG. 7. The message may include a TC-ID and report filters. The message may be received from an IMF, a WTRU, an NF, an AF and may be received via a NEF.

The UDM/UDR may process the traceability report retrieval. For example as shown in 705 and 709 of FIG. 7. The UDM/UDR may retrieve the traceability entries associated with a TC-ID. The UDM/UDR may generate a traceability report considering the report filters

The UDM/UDR may send a message indicating a traceability report. For example as shown in 706 and 710 of FIG. 7. The message may include a traceability report associated with a TC-ID. The message may be sent to an IMF, a WTRU, an NF, an AF and may be sent via a NEF.

The term intent consumer may be used to describe a functional entity that may request the activation of an intent; thus, the term intent consumer and intent requestor may be used interchangeably.

Intent information defines information elements that may be used to describe an intent. This information may be associated with a pre-defined intent, which is an intent defined in the system before it has been activated by an intent consumer. This information may be associated with an active intent, which is an intent instance that has been activated by an intent consumer.

An intent identifier (I-ID) uniquely identifies an intent type in a system that publishes and manages pre-defined intents. The I-ID may be used to identify and manage different intent types.

An intent instance identifier (II-ID) uniquely identifies an instance of an active intent. For example, in a system, a first intent (e.g., with an I-ID) that is activated has a first II-ID, and a second intent (e.g. with the same I-ID) that is activated has a second II-ID such that the first and second active intent may be uniquely identified.

An intent semantic description is a description of the objective of an intent which may be a textual description. The semantic description may typically be provided and/or understood by a user but may also be interpreted and/or translated by a software function, such as ML model, to generate a list of actions for realizing the objective. For example, the semantic description of an intent may be “Establish an XR session with a minimum QoS of X at the edge”.

An intent configuration parameters define the configuration parameters that are associated with an intent. For example, considering the intent “Establish an XR session with a minimum QoS of X at the edge”, it may be necessary to provide an application identifier and/or service identifier for establishing the XR session, to provide WTRU identifiers to identify a subscribed edge computing service provider and to provide a QoS value. Each intent, dependent on its objectives, may have a different list of configuration parameters.

Intent management parameters may provide to the IMF information about the intent lifecycle. For example, the management parameters may indicate that an intent should be activated only in a certain location, at a certain time of day or for a certain period. The management parameters may also include notification information (e.g., uniform resource locator (URL), uniform resource identifier (URI), Internet Protocol (IP) address, port) for reporting events associated with an intent.

An intent traceability configuration identifier may identify a traceability configuration that is applicable for the intent.

An intent consumer identifier uniquely identifies a requestor of intent functionality. The requestor may be a WTRU, an NF, or an AF and the identifier may respectively be a generic public subscription identifier (GPSI), a NF identifier or an AF identifier. The requestor identifier may be used to authorize a request that is associated with an intent at the IMF or at the UDM/UDR, for example to activate, update, terminate or obtain a traceability report associated with an intent.

Intent consumer security credentials identify the security material (e.g., key, token, etc.) that the requestor must provide to the IMF and/or the UDM/UDR for intent related interactions. The security credentials may be used to authorize interactions.

Traceability configuration information defines information elements that may be considered for collecting traceability information.

A traceability configuration identifier uniquely identifies a traceability configuration. This identifier may be used to identify and manage different traceability configurations in the system.

A traceability scope identifies the functional entity instances and or active intent instances for which the traceability information is captured. For example, the traceability scope may identify subsystems, WTRUs (e.g., GPSI), NFs, AFs, IMFs, or intents (I-ID), intent instances (II-ID) for which trace information should be captured. The traceability scope may also identify subsystems such as edge hosting environments or deployments, trust domains or user-associated services across devices.

The intent traceability configuration may be stored in the UDM/UDR and functional entities requiring the configuration may retrieve the configuration with the UDM/UDR via the traceability configuration identifier if required.

FIG. 2 shows an example procedure for registering an active intent with a UDM/UDR to enable traceability.

The intent consumer 201 may be an Application Function (AF), a Network Function (NF) or a WTRU that needs or desires to activate an intent for realizing an objective. The intent consumer may also be an instance of an IMF.

In an example, an intent objective may be a simple task such as “configuring a minimum QoS for a given traffic flow” which may require interacting with a single network subsystem such as the core network (CN). In an example, an intent may be a complex task such as “discovering an XR application executing at a nearby edge for establishing an XR session with a given QoS”. This example is more complex because the intent requires interacting with several subsystems such as the edge subsystem for discovering the Edge Application Server (EAS), with the management system to instantiate the EAS if required and with the CN for configuring the minimum QoS for the provided EAS.

As a pre-requisite, the intent consumer may have been pre-configured with the IMF address or may have discovered an available IMF in the network, for example by using the Common API Framework (CAPIF) that allows to discover API published for discovery and may be configured to make the IMF API discoverable.

An IMF deployed in a network may support pre-defined intents or semantic intents or both. A semantic intent is an intent that is expressed in a free form format and from which the IMF may interpret the meaning. Capabilities of the IMF to support pre-defined or semantic intents may be communicated to the intent consumer via pre-configuration or via a procedure such as the procedure for discovering an IMF or a procedure for registering the intent consumer with the IMF. The intent consumer may discover pre-defined intents supported by the IMF via a procedure for discovering published intents, for example by performing an intent discovery procedure with the IMF or with CAPIF.

The intent consumer 201 may send receive a request message to activate an intent 210 (e.g., activate intent request message) to the IMF 202. The request message may include information about the intent and information about the requestor. The intent information may include, for example, an intent identifier, an intent semantic description, intent configuration parameters and/or intent management parameters. The information about the requestor may include, for example, a requestor identifier (e.g., a GPSI, an NF identifier or an AF identifier) and/or security credentials of the requestor. The IMF may use the intent information to determine the actions required to realize the intent objective and may use the requestor information to authorize the intent activation or to provide traceability about the intent.

The request message may include traceability configuration information and/or a traceability configuration identifier that provides configuration information associated with the intent to be activated. The IMF may use the provided information to configure traceability of the activated intent. For example, the traceability configuration information may indicate that the traceability information related to an intent should only include traceability information for a given subsystem or for a specific network function such that only information of the specific subsystem or network function is collected.

The IMF 202 may process the intent activation request message 220 from the intent consumer 201. The processing may, for example, include authorizing the intent activation request, translating the intent into one or more actions and/or assigning an intent instance identifier (II-ID) to the requested intent. The II-ID may be an identifier that uniquely identifies the intent instance being activated and the II-ID may be assigned by the IMF once the IMF determines that an instance needs to be activated. For example, different activated intent instances may share the same intent identifier (e.g., same I-ID) but each have their unique intent instance identifier (e.g., different II-ID). Translating an intent into one or more actions may be dependent on whether the intent is pre-defined or semantic. For example, a pre-defined intent may be associated with a pre-determined list of actions to be performed in a pre-defined order while a semantic intent may require to be interpreted by an AIML model for translating intents into actions.

The IMF may determine that the intent activation request message 210 may correspond to already registered intent registrations which may be leveraged for this processing. The IMF may therefore create and maintain associations between one or more actions of the action list, intent activation requests, one or more corresponding intent types, and one or more active intent instances.

The IMF 202 may send an active intent registration request message 230 to the UDM/UDR 203 to create an active intent entry. The active intent registration request message may include the IMF identifier and the assigned II-ID for the intent and may additionally include the intent information and requestor information. The active intent entry may be used to manage the traceability information of an intent when it is processed in a layered system, as described further below.

The active intent registration request message may include traceability configuration information and/or a traceability configuration identifier that provides configuration information associated with the active intent. The UDM/UDR may use the provided information to configure traceability of the activated intent. For example, the traceability information may be provided to the UDM/UDR, and the UDM/UDR may consider the traceability configuration to determine if the traceability information should be collected.

The UDM may process the active intent registration request to create an active intent entry 240 in the UDR. The processing may include creating a traceability correlation identifier (TC-ID) for the active intent. The TC-ID is an identifier that uniquely identifies a root active intent and that may be used by the UDM/UDR to provide traceability on subsystem intents and/or API invocations that may have been triggered by the root active intent across network subsystems. The TC-ID may differ from the II-ID. For example, when a root active intent which is assigned a first II-ID and triggers the execution of multiple subsystem intents which have their own respective II-IDs, it is necessary to have a unique identifier (e.g., the TC-ID) to correlate that the multiple intents (e.g., multiple II-IDs) are associated to a root intent.

In other words, an intent activation may result in activating multiple intents where each intent has its own II-ID and where all activated intent shares the same TC-ID.

Upon creating an active intent entry in the UDR, the UDM may associate the TC-ID with the information received in the request, including the II-ID, the IMF-ID, the intent information, and the requestor information.

The UDM/UDR 203 may send an active intent registration response message 250 to the IMF 202. The active intent registration response message may include an indication that the active intent entry has been created and an indication of the assigned TC-ID.

The IMF 202 may perform response processing and may associate the TC-ID, which may be provided by the UDM/UDR, with the II-ID 260. This association may allow the IMF to obtain the TC-ID when managing the active intent. The IMF 202 may include a proposed TC-ID in the active intent registration request 230. The UDM/UDR 203 may use the provided TC-ID in 240 instead of creating a TC-ID for the active intent. The UDM/UDR may verify if the provided TC-ID is already in use prior to associating the provided TC-ID with the active intent. If the provided TC-ID is in use, the UDM/UDR may reject the active intent registration request or may assign a new TC-ID instead of using the provided TC-ID.

The IMF 202 may perform the intent activation actions 270, for example as determined in the request processing step 220.

The IMF 202 may send an activate intent response message 280 to the intent consumer 201. The activate intent response message may include the II-ID assigned to the activated intent by the IMF, the TC-ID assigned by the UDM/UDR and intent response information. The II-ID may be used by the intent consumer in interactions (e.g., receiving or sending messages) with the IMF, for example, to send intent management messages to the IMF or to associate received messages from the IMF with the activated intent. The intent consumer may use the TC-ID to provide traceability information to the system, for example, to provide QoE traceability information associated with an active intent.

In some embodiments, the intent activation process may be asynchronous such that the activate intent response (e.g., step 280) is returned immediately after step 220 is completed, and a second message (e.g., activate intent notification) is sent in step 280 once the intent is activated.

For the asynchronous intent activation, a time value may be provided in the response message to indicate to the intent consumer an approximation of the time before the intent activation is expected to complete. The intent consumer may use the time value to start a timer in expectation of the notification.

FIG. 3 shows an exemplary embodiment of layered intent activation traceability including two layers of intent activation

For the procedure described in FIG. 3, intent-X refers to a first intent (e.g., a root intent) that is activated by an intent consumer and intent-X1 refers to a second intent that is performed as a determined action associated with intent-X.

For the procedure described in FIG. 3, the Anchor IMF 302 is a first IMF that has been discovered by the intent consumer 301 and the IMF for Subsystem-1 304 is a second IMF that has been discovered by the Anchor IMF 302 for performing actions with subsystem-1. For example, the Anchor IMF 302 may be a first IMF that is exposed externally to third parties via CAPIF while the IMF for Subsystem-1 304 may be a second IMF that is exposed via the NEF for interactions with the CN.

The intent consumer 301 (e.g., AF/NF/WTRU) may send an activate intent request message (e.g., intent activation request) 310 to the Anchor IMF 302. The activate intent request message may indicate activation of intent-X and provide the requestor information. This step corresponds to step 210 of FIG. 2.

The IMF Anchor 302 may process the intent activation request 320. The IMF Anchor may authorize the intent activation request from the requestor, translate intent-X in activation actions, assign an II-ID (e.g., II-ID-X0) to intent-X activation, as described in step 220 of FIG. 2. The Anchor IMF may register active intent-X with the UDM/UDR 303, obtain a TC-ID for active intent-X and associate the obtained TC-ID with the assigned II-ID-X0, as described in step 230 to step 260 of FIG. 2. The Anchor IMF may have determined that activation of intent-X1 from subsystem-1 is an action to be performed for realizing activation of intent-X.

The IMF Anchor 302 may send an activate intent request message 330 to the IMF for Subsystem-1 304. The activate intent request message may include the intent information for intent-X1, the requestor information which is the IMF Anchor information (e.g., as the requestor of intent-X1), and includes the TC-ID, obtained in step 320. The TC-ID may be included to indicate to the IMF for Subsystem-1 that intent-X1 is associated with intent-X and is part of the activation of a root intent. The message described in step 330 is similar to the message described in step 210 of FIG. 2, with the addition of the TC-ID information.

The activate intent request message may include traceability configuration information and/or a traceability configuration identifier that provides configuration information associated with the intent to be activated. The IMF may use the provided information to configure traceability of the activated intent.

The IMF for Subsystem-1 304 may process the activate intent request 340. The IMF for Subsystem-1 may authorize the activate intent request from the requestor, translate intent-X1 in activation actions, assign an II-ID (e.g., II-ID-X1) to intent-X1 activation, as described in step 220 of FIG. 2. The IMF for Subsystem-1 does not register active intent-X1 with the UDM/UDR based on the request including a TC-ID. The IMF for Subsystem-1 associates the provided TC-ID with the assigned II-ID-X1, as described in step 260 of FIG. 2. The IMF for Subsystem-1 may have determined that activation of intent-X1 requires sending a first SBI message to a first Network Function (NF1 ) 305 and a second SBI message to a second Network Function (NF2 ) 306 based on intent-X1 translation.

The IMF for Subsystem-1 304 may send a first SBI message 350 to NF1 305 and send a second SBI message 355 to NF2 306 and respectively receive a first 350 and a second 355 response from NF1 and NF2. For example, a first SBI message may be to perform traffic influence on a specific traffic flow and the second SBI message may be to set a minimum QoS on the same flow.

The IMF for Subsystem-1 304 may send an active intent update request message 360 to the UDM/UDR 303 for providing traceability information about the activation of intent-X1. The intent update request message may include the TC-ID, the IMF for Subsystem-1 identifier, the II-ID for intent-X1 (e.g., II-ID-X1) and an action list information. The action list information may include details of the actions taken as part of the activation of intent-X1. For example, the action list information may include the NF1 identifier, the endpoint information (e.g., URL, URI, IP address, port) used to make the SBI request to NF1, the information provided in the SBI message, the response received from NF1 and timing information. For example, the action list information may additionally include information for the SBI interaction with NF2, and the information for the SBI interaction with NF2 may be similar to the action list information for NF1 described herein.

The IMF for Subsystem-1 may determine to send the active intent update request message based on the traceability configuration information and/or a traceability configuration identifier. For example, the IMF for Subsystem-1 may send the message if the scope of the traceability information includes the subsystem, the NF, or the active intent. The IMF for Subsystem-1 304 may obtain the traceability configuration information and/or a traceability configuration identifier if it is included in the activate intent request message 330. The IMF for Subsystem-1 304 may obtain the traceability configuration information and/or a traceability configuration identifier associated with the TC-ID from the UDM/UDR 303 if it is not included in the activate intent request message 330.

The UDM/UDR 303 may update the active intent entry associated with the TC-ID. The UDM/UDR may store the information provided in the active intent update request message 360 in the active intent entry.

The UDM/UDR may determine to store the information based on the traceability configuration information and/or a traceability configuration identifier. For example, the UDM/UDR may store the information if the scope of the traceability information includes the subsystem, the NF, or the active intent for which the active intent update was received.

Although not shown in FIG. 3, it can be appreciated that if a subscriber to the UDM/UDR has subscribed for traceability updates associated with the TC-ID, then the UDM/UDR may issue a notification to the subscriber. For example, the Anchor IMF may have subscribed to receive notifications from the UDM/UDR on updates associated with the TC-ID.

The UDM/UDR may have a capability to validate intent accuracy. The UDM/UDR may use the intent information (e.g., from step 330 and 340) along with the intent's traceability information (e.g., from step 360) to determine whether the intent objective was successful. The UDM/UDR may have this capability or may use AI/ML capabilities (local or from another NF) to determine the intent success and may additionally notify a subscriber about that determination as described herein.

The IMF for Subsystem-1 304 may send an activate intent response message 380 for activation of intent-X1 to the IMF Anchor 302. The activate intent response message may include II-ID-X1, the TC-ID that was previously provided in the request in step 330, and intent response information. This step is similar to step 280 of FIG. 2.

Upon completing the determined actions for activation of intent-X, the IMF Anchor 302 may send an activate intent response message 390 for activation of intent-X to the intent consumer 301. The response may include II-ID-X, the TC-ID that was obtained in step 320, and intent response information. This step is similar to step 280 of FIG. 2.

FIG. 4 shows an exemplary embodiment of layered intent activation traceability including three layers of intent activation and additional API calls.

For the procedure described in FIG. 4, intent-X refers to a first intent (e.g., a root intent) that is activated by an intent consumer and intent-X1 refers to a second intent that is performed as a determined action associated with intent-X and intent-X2 refers to a third intent that is performed as a determined action associated with intent-X1. In addition to intent-X1, an API call is determined as an additional action to be performed with intent-X1.

For the procedure described in FIG. 4, the Anchor IMF 441 is a first IMF that has been discovered by the intent consumer 440 and the IMF for Subsystem-1 443 is a second IMF that has been discovered by the Anchor IMF 441 for performing actions with Subsystem-1 and the IMF for Subsystem-2 446 is a third IMF that has been discovered by the IMF for Subsystem-1 443 for performing actions with Subsystem-2. For example, the Anchor IMF 441 may be a first IMF that is exposed externally to third parties via CAPIF while the IMF for Subsystem-1 443 may be a second IMF that is exposed via the NEF for interactions with the CN while the IMF for Subsystem-2 446 may be a third IMF that is exposed for interactions with the management system.

The intent consumer 440 may send an activate intent request message 401 (e.g., activation request) to the Anchor IMF 441. This step is similar to step 310 from FIG. 3. The activate intent request message may include intent-X information and requestor information.

The IMF Anchor 441 may process the activation request 402. This step is similar to step 220 from FIG. 2. In this embodiment, the IMF anchor has determined that intent-X may be realized by performing two actions including firstly activating intent-X1 with Subsystem-1 and secondly performing a procedural API call with Subsystem-3.

The IMF Anchor 441 may send an activate intent request message (e.g., activation request) 403 to the IMF for Subsystem-1 443. This step is similar to step 330 from FIG. 3. The IMF Anchor 441 may receive an activate intent response message from the IMF for Subsystem-1 443.

The IMF for Subsystem-1 443 may process the activation request 404. This step is similar to step 340 from FIG. 3. In this embodiment, the IMF for Subsystem-1 has determined that intent-X1 may be realized by performing three actions including firstly sending a first SBI message to NF1, secondly sending a second SBI message to NF2, and thirdly activating intent-X2 with Subsystem-2.

The IMF for Subsystem-1 443 may send a first SBI message (405a) to NF1 444 and may send a second SBI message (405b) to NF2 445. This step is similar to step 350 from FIG. 3.

The IMF for Subsystem-1 443 may send an activate intent request message 406 to the IMF for Subsystem-2 446. The activate intent request message may include the intent information for intent-X2, the requestor information which is the IMF for Subsystem-1 information (e.g., as the requestor of intent-X2), and includes the TC-ID obtained in step 403. The TC-ID is included to indicate to the IMF for Subsystem-2 that intent-X2 is associated with intent-X and is part of the activation of a root intent. The message described in step 406 is similar to the message described in step 210 of FIG. 2 with the addition of the TC-ID information. The IMF for Subsystem-1 443 may receive an activate intent response message 406 from the IMF for Subsystem-2 446

The activate intent request message may include traceability configuration information and/or a traceability configuration identifier that provides configuration information associated with the intent to be activated. The IMF for Subsystem-1 443 may use the provided information to configure traceability of the activated intent.

The IMF for Subsystem-2 446 may process the activate intent request message 407. The IMF for Subsystem-2 may authorize the activate intent request from the requestor. The IMF for Subsystem-2 may translate intent-X2 in activation actions. The IMF for Subsystem-2 may assign an II-ID (e.g., II-ID-X2) to intent-X2 activation as described in step 220 of FIG. 2. The IMF for Subsystem-2 may not register active intent-X2 with the UDM/UDR based on the request including a TC-ID. The IMF for Subsystem-2 may associate the provided TC-ID with the assigned II-ID-X2 as described in step 260 of FIG. 2. Additionally, the IMF for Subsystem-2 may have determined that activation of intent-X2 requires performing internal actions that are not shown in FIG. 4.

The IMF for Subsystem-2 446 may send an active intent update request message 408 to the UDM/UDR for providing traceability information about the activation of intent-X2. The active intent update request message may include the TC-ID, the IMF for Subsystem-2 identifier, the II-ID for intent-X2 (e.g., II-ID-X2) and an action list information. The action list information may include details of the actions taken as part of the activation of intent-X2. For example, the action list information may include a Subsystem-2 identifier, the description of the internal action performed in Subsystem-2 and the outcome of the internal actions taken by Subsystem-2.

The IMF for Subsystem-2 446 may determine to send the active intent update request based on the traceability configuration information and/or a traceability configuration identifier. For example, the IMF may send the message if the scope of the traceability information includes the subsystem, the NF, or the active intent.

The UDM/UDR 442 may update the active intent entry 409 associated with the TC-ID by adding information about activation of intent-X2. This step is similar to step 370 from FIG. 3.

Upon completion of the actions determined for activation of intent-X1, the IMF for Subsystem-1 443 may send an active intent update request message 410 to the UDM/UDR 442. This step is similar to step 360 from FIG. 3 and the action list information additionally includes information about the outcome of activation of intent-X2.

The IMF for Subsystem-1 may determine to send the active intent update request message based on the traceability configuration information and/or a traceability configuration identifier. For example, the IMF for Subsystem-1 may send the message if the scope of the traceability information includes the subsystem, the NF, or the active intent. The IMF for Subsystem-1 may receive an active intent update response message from the UDM/UDR.

The UDM/UDR 442 may update the active intent entry 411 associated with the TC-ID by adding information about activation of intent-X1. This step is similar to step 370 from FIG. 3.

In steps 412 to 415, a first alternative to intent framework traceability for API calls that are intent aware is described.

The IMF Anchor 441 may make an API request (e.g., send a request message) to Subsystem-3 447 and the request may include request parameter information according to the API definition, and may include the TC-ID.

The message may include traceability configuration information and/or a traceability configuration identifier that provides configuration information associated with the intent to be activated. The Subsystem-3 may use the provided information to configure traceability of the API request.

The API request may be processed 413 by a functional entity in Subsystem-3 447.

The functional entity processing the API request in Subsystem-3 447 may send an active intent update request message 414 to the UDM/UDR 442 for providing traceability information about the API request processing. The request may include the TC-ID, the Subsystem-3 identifier and/or the functional entity processing the request in Subsystem-3, and an action list information. The action list information may include details of the actions taken as part of processing the API request in Subsystem-3. For example, the action list information may include Subsystem-3 identifier, the description of the internal action performed in Subsystem-3 and the outcome of the internal actions taken by Subsystem-3. The functional entity processing the API request in Subsystem-3 447 may receive an active intent update response message 414 from the UDM/UDR 442.

Subsystem-3 may determine to send the active intent update request message based on the traceability configuration information and/or a traceability configuration identifier. For example, the Subsystem-3 may send the message if the scope of the traceability information includes the subsystem, the NF, or the active intent.

Subsystem-3 447 may send an API response 415 to the IMF Anchor 441, including the outcome of the API request processing in Subsystem-3.

In steps 416 to 419, a second alternative to intent framework traceability for API calls that are intent unaware is described.

The IMF Anchor 441 may make an API request (e.g., send a request message) 416 to Subsystem-3 447 and the request may include request parameter information according to the API definition.

The API request may be processed 417 by a functional entity in Subsystem-3 447.

Subsystem-3 447 may send an API response message 418 to the IMF Anchor 441, including the outcome of the API request processing in Subsystem-3.

The IMF Anchor 441 may send an active intent update request message 419 to the UDM/UDR 442 for providing traceability information about the API request processing. The request may include the TC-ID, the Subsystem-3 identifier, and an action list information. For example, the action list information may include Subsystem-3 identifier and the outcome of the internal actions taken by Subsystem-3. The IMF Anchor 441 may receive an active intent update response message 419 from the UDM/UDR 442

The IMF Anchor may determine to send the active intent update request message based on the traceability configuration information and/or a traceability configuration identifier. For example, the IMF anchor may send the message if the scope of the traceability information includes the subsystem, the NF, or the active intent.

The UDM/UDR 442 may handle the active intent update request 420 from step 415 or from step 419. The UDM/UDR may update the active intent entry associated with the TC-ID by adding information about API request processing and/or outcome. This step is similar to step 370 from FIG. 3.

Upon completing the determined actions for activation of intent-X, the IMF Anchor 441 may send an activate intent response message 421 for activation of intent-X to the intent consumer 440. The response message may include II-ID-X, the TC-ID that was obtained in step 402, and intent response information. This step is similar to step 280 of FIG. 2.

FIG. 5 shows an exemplary embodiment of layered intent events traceability.

An intent may be activated 510 according to, for example the exemplary embodiments of FIG. 3 or FIG. 4.

The IMF for Subsystem-1 504 (e.g., CN) may detect or determine that an active intent (e.g., intent-X1) event 520, such as an even indicating that the active intent cannot be fulfilled anymore. The detection by the IMF for Subsystem-1 may be associated with the IMF for Subsystem-1 subscribing to events associated with actions associated with intent-X1. For example, the IMF for Subsystem-1 may have subscribed for events with a first NF (i.e., NF1 ) and/or a second NF (i.e., NF2 ) and may receive such an event indicating for example that a requested QoS cannot be met anymore. Alternatively, the IMF for Subsystem-1 may be able to monitor the state of a requested action instead of subscribing to events.

The IMF for Subsystem-1 504 may process the detected active intent event 530. For example, the IMF for Subsystem-1 may determine as a corrective action to deactivate intent-X1 due to the event detection. Depending on intent-X1, it may be appreciated that the IMF for Subsystem-1 may also determine a different corrective action, for example, the IMF for Subsystem-1 may determine to perform a second activation of intent-X1 with the same or different parameters (e.g., different minimum QoS). Corrective actions may be pre-determined for an intent-X1 or may be determined, for example, based on an AI model that may determine corrective actions based on events.

The IMF for Subsystem-1 504 may send an active intent update request message 540 to the UDM/UDR 503 for providing traceability information about the deactivation of intent-X1. This request message is similar to step 360 of FIG. 3. The request message may include the TC-ID, the IMF for Subsystem-1 identifier, the II-ID for intent-X1 (e.g., II-ID-X1) and an action list information. The action list information may include details of the actions taken as part of the deactivation of intent-X1. For example, the action list information may include the NF1 identifier, the endpoint information (e.g., URL, URI, IP address, port) used to make the SBI request to NF1 (e.g., if the deactivation included sending a SBI message), the information provided in the SBI message, the response received from NF1 and timing information. The IMF for Subsystem-1 504 may receive an active intent update request message 540 from the UDM/UDR 503

The IMF for Subsystem-1 may determine to send the active intent update request message based on the traceability configuration information and/or a traceability configuration identifier. For example, the IMF for Subsystem-1 may send the message if the scope of the traceability information includes the subsystem, the NF, or the active intent.

The UDM/UDR 503 may update the active intent entry associated with the TC-ID 550. The UDM/UDR may store the information provided in the message described in step 540 in the active intent entry.

The UDM/UDR may determine to store the information based on the traceability configuration information and/or a traceability configuration identifier. For example, the UDM/UDR may store the information if the scope of the traceability information includes the subsystem, the NF, or the active intent for which the active intent update was received.

The IMF for Subsystem-1 504 may send an active intent notification message 560 to the IMF Anchor 502 for indicating the event (e.g., deactivation) associated with intent-X1. The notification message may include the intent-X1 instance identifier (e.g., II-ID-X1) and the TC-ID that was previously provided when intent-X1 was activated (e.g., in step 330 of FIG. 3), and intent notification information. The intent notification information may include information about the detected event, information about the decided corrective action and information about the outcome of the corrective action.

The IMF Anchor may have provided notification endpoint information (e.g., URL, URI, IP address, port) to the IMF for Subsystem-1 when it activated intent-X1, for example, in step 330 of FIG. 3, that the IMF for Subsystem-1 may retrieve this endpoint information based on the detected event, and that the IMF for Subsystem-1 may use the endpoint information to notify the IMF Anchor.

Alternatively or additionally to step 560, the UDM/UDR 503 may send an active intent notification message 570 to the IMF Anchor 502 for indicating the event (e.g., deactivation) associated with intent-X1. The notification message is similar to the message described in step 560 and may include the information provided by the IMF for Subsystem-1 in step 540.

The IMF Anchor may have provided notification endpoint information (e.g., URL, URI, IP address, port) to the UDM/UDR when it registered the active intent-X in step 230 of FIG. 2, that the UDM/UDR may retrieve this endpoint information based on the TC-ID, and that the UDM/UDR may use the endpoint information to notify the IMF Anchor.

Upon receiving at least one of the notification 560 or 570, the IMF Anchor 502 may use the TC-ID from the notification to identify that the event is related to intent-X and more specifically identify based on II-ID-X1 that the event is related to intent-X1. The IMF Anchor may retrieve the intent consumer information and may notify the intent consumer about the notified event, for example by sending an active intent notification message 580 to the intent consumer 501. It may be appreciated that the intent consumer may have provided a notification endpoint (e.g., URL, URI, IP address, port) when it initially activated intent-X as shown in step 310 of FIG. 3. Upon receiving the notification event, the intent consumer may evaluate whether the event requires a corrective action from the intent consumer. For example, a corrective event may include terminating active intent-X, activating a new intent or updating active intent X with new intent parameters.

FIG. 6 shows an exemplary embodiment of layered intent QoE traceability.

In the procedure of FIG. 6, the Quality of Experience (QoE) represents the overall network service experience perceived by the intent consumer which may be a WTRU, an AF, or a NF. The QoE in this procedure is related to an activated intent and the QoE measures how well the network and the application (e.g., present on the WTRU, the AF or NF) satisfy the user expectations. For example, the QoE may be based on measurements at the intent consumer of network performance metrics (e.g., latency, throughput, packet loss, jitter, etc.), may be related to application behavior (e.g., buffering events, experienced video resolution, flow mis-alignment in XR applications, etc.) or based on user expectations (e.g., video streaming delay, choppiness, dropped voice calls, etc.).

Allowing an intent consumer to provide experienced QoE associated with an activated intent may provide beneficial information when diagnosing system issues which may be enabled by the procedure described in FIG. 6.

An intent (e.g., intent-Y) may be activated 601 according to, for example, the exemplary embodiments of FIG. 2, FIG. 3, or FIG. 4.

Step 602 to 606 provide a first alternative to provide layered intent QoE traceability via the IMF by activating an intent (e.g., intent-X) for reporting QoE traceability about an activated intent-Y.

An intent consumer 620 may activate intent-X for the purpose of reporting QoE information associated with intent-Y that was previously activated. It may be appreciated that intent-Y may be a long-lived intent that was previously activated, and that intent-X may be a short-lived intent only for the purpose of reporting QoE associated with intent-Y.

The intent consumer 620 may send an intent activate request message 602 to the IMF Anchor 630. The request message may include intent information (e.g., intent-X indicating that the intent is for QoE reporting), information about the intent consumer and the TC-ID-Y associated with intent-Y for which the QoE is reported. This request message may be similar to step 210 of FIG. 2. with the addition of the TC-ID-Y associated with intent-Y for which the QoE is reported and the addition of the QoE information that is being reported.

The IMF Anchor 630 may process the intent-X activation request 603. This step is similar to step 220 from FIG. 2. In this exemplary embodiment, the IMF Anchor has determined that intent-X may be realized by updating an active intent in the UDM/UDR 640.

It may be appreciated that the IMF Anchor may first obtain a TC-ID-X associated with the requested intent from the UDM/UDR, and may then determine that an update to intent-Y is required and may retrieve the information associated TC-ID-Y such as II-ID-Y and intent-Y information that was associated with TC-ID-Y at intent-Y activation.

The IMF Anchor 630 may send an active intent update request message 604 to the UDM/UDR 640. The intent update request message may include the TC-ID-Y (e.g., the traceability correlation identifier for which QoE is reported), the IMF Anchor information as the requestor and the action list. The action list may include the QoE information associated with intent-Y and intent-Y information retrieved in step 603. The IMF Anchor 630 may receive an active intent update response message 604 from the UDM/UDR 640

The UDM/UDR 640 may update the active intent-Y entry associated with the TC-ID-Y 605. The UDM/UDR may store the information provided in the message described in step 604 in the active intent-Y entry.

It may be appreciated that UDM/UDR may determine to store the information based on the traceability configuration information and/or a traceability configuration identifier associated with intent-Y. For example, the UDM/UDR may store the information if the scope of the traceability information includes the subsystem, the NF, or the active intent for which the active intent update was received.

The IMF Anchor 630 may send an activate intent response message 606 to the intent consumer 620. The activate intent response message may include the II-ID-X assigned to the activated intent by the IMF, the TC-ID-X assigned by the UDM/UDR and intent response information. This message may be similar to step 280 from FIG. 2

Step 607 to 610 provide a second alternative to provide layered intent QoE traceability via the UDM/UDR when an intent consumer has access to the UDM/UDR.

The intent consumer 620 may send an active intent update request message 607 to the UDM/UDR 640. The active intent update request message includes the TC-ID-Y (e.g., the traceability correlation identifier for which QoE is reported), the requestor information which is the intent consumer identifier and the action list. The action list may include the QoE information associated with intent-Y and II-ID-Y.

The UDM/UDR 640 may update the active intent-Y entry associated with the TC-ID-Y 608. The UDM/UDR may store the information provided in the message described in step 607 in the active intent-Y entry.

It may be appreciated that UDM/UDR may determine to store the information based on the traceability configuration information and/or a traceability configuration identifier associated with intent-Y. For example, the UDM/UDR may store the information if the scope of the traceability information includes the subsystem, the NF, or the active intent for which the active intent update was received.

The UDM/UDR 640 may send an active intent update response message 609 to the intent consumer 620. The response may include the TC-ID-Y and intent response information (e.g., whether the intent QoE reporting was successful).

The UDM/UDR 640 may send an active intent notification message 610 to the IMF Anchor 630 for indicating the event (e.g., QoE reporting) associated with intent-Y. The active intent notification message may include the information provided with the QoE reporting.

It may be appreciated that the IMF Anchor may have provided notification endpoint information (e.g., URL, URI, IP address, port) to the UDM/UDR when it registered the active intent-Y, for example, as in step 230 of FIG. 2, that the UDM/UDR may retrieve this endpoint information based on the TC-ID-Y, and that the UDM/UDR may use the endpoint information to notify the IMF Anchor.

Upon determining that QoE reporting for intent-Y is provided in step 603 or being notified by the UDM/UDR 640 about intent QoE event in step 610, the IMF anchor 630 may determine that a corrective action is required based on the reported QoE for intent-Y 611. The IMF Anchor may use the TC-ID-Y to identify that the event is related to intent-Y and more specifically identify that the event is related to intent-Y. The IMF Anchor may evaluate whether the QoE indication in 603 or in 610 requires a corrective action. For example, a corrective event could include terminating active intent-Y, activating a new intent or updating active intent Y with new intent parameters.

FIG. 7 shows an exemplary embodiment of layered intent traceability reporting.

In the procedure of FIG. 7, a report consumer 720 may obtain a traceability report for a previously activated intent.

In a first alternative, the report consumer may activate a first intent (e.g., intent-X) for retrieving a traceability report on a second intent (e.g., intent-Y).

In a second alternative, the report consumer may retrieve a traceability report from the UDM/UDR if it has access to the UDM/UDR.

An intent (e.g., intent-Y) may be activated 701, for example, according to the exemplary embodiments of FIG. 2, FIG. 3, or FIG. 4.

Step 702 to 707 provide a first alternative to provide layered intent traceability report via the IMF 730 by activating an intent (e.g., intent-X) for providing a traceability report about an activated intent-Y.

An intent consumer 720 may activate intent-X for the purpose of retrieving a traceability report associated with intent-Y that was previously activated. It may be appreciated that intent-Y may be a long-lived intent that was previously activated, and that intent-X may be a short-lived intent only for the purpose of retrieving a traceability report for intent-Y.

The report consumer 720 may send an activate intent request message 702 to the IMF Anchor 730. The request message may include intent information (e.g., intent-X indicating that the intent is for retrieving a traceability report), information about the report consumer and the TC-ID-Y associated with intent-Y for which the traceability report is retrieved. This message may be similar to step 210 of FIG. 2 with the addition of the TC-ID-Y associated with intent-Y for which the traceability report is retrieved and the addition of report filters. Report filters may be used to control the content of the report. For example, report filters may be used to limit the report content to the IMF Anchor actions associated with intent-Y or to target report information from a specific subsystem or to target report information associated with a time period.

The IMF Anchor 730 may process the intent-X activation request 703. This step is similar to step 220 from FIG. 2. In this exemplary embodiment, the IMF Anchor has determined that intent-X may be realized by requesting an active intent report from the UDM/UDR 740.

It may be appreciated that the IMF Anchor may first obtain a TC-ID-X associated with the requested intent from the UDM/UDR, and may then determine that a request for an active intent report for intent-Y is required and may retrieve the information associated TC-ID-Y such as II-ID-Y and intent-Y information that was associated with TC-ID-Y at intent-Y activation.

The IMF Anchor 730 may send an active intent report request message 704 to the UDM/UDR 740. The active intent report request message may include the TC-ID-Y (e.g., the traceability correlation identifier for which QoE is reported), the IMF Anchor information as the requestor and the report filters.

The UDM/UDR 740 may retrieve the active intent-Y entries associated with the TC-ID-Y and according to the provided report filters 705. The UDM/UDR may obtain traceability information that was stored in the UDM/UDR active intent entry by different entities, including subsystem's intent activations as described FIG. 3 and FIG. 4, API invocation as described in FIG. 4, event detection as described in FIG. 5 and QoE reporting events as described in FIG. 6. It may be appreciated that traceability information may also be stored in the UDM/UDR by the IMF Anchor.

The UDM/UDR 740 may send an active intent report response message 706 to the IMF Anchor 730. The active intent report response message may include the TC-ID-Y and the traceability report information determined by the UDM/UDR in step 705.

The IMF Anchor 730 may send an activate intent response message 707 to the report consumer 720. The activate intent response message may include the II-ID-X assigned to the activated intent by the IMF, the TC-ID-X assigned by the UDM/UDR and intent response information. The intent response information may include the traceability report information determined by the UDM/UDR in step 705. This message may be similar to step 280 from FIG. 2.

Step 708 to 710 provide a second alternative to provide layered intent traceability report via the UDM/UDR when a report requestor has access to the UDM/UDR.

The report consumer 720 may send an active intent report request message 708 to the UDM/UDR 740. The active intent report request message may include the TC-ID-Y (e.g., the traceability correlation identifier for which the report is requested), the requestor information which is the report consumer identifier and the report filters. Report filters may be used to control the content of the report, for example report filters may be used to limit the report content to the IMF Anchor actions associated with intent-Y or to target report information from a specific subsystem or to target report information associated with a time period.

The UDM/UDR 740 may retrieve the active intent-Y entries associated with the TC-ID-Y 709 and according to the provided report filters as described in step 708.

The UDM/UDR 740 may send an active intent report response message 710 to the report consumer 720. The active intent report response message may include the TC-ID-Y and the traceability report information determined by the UDM/UDR in step 709.

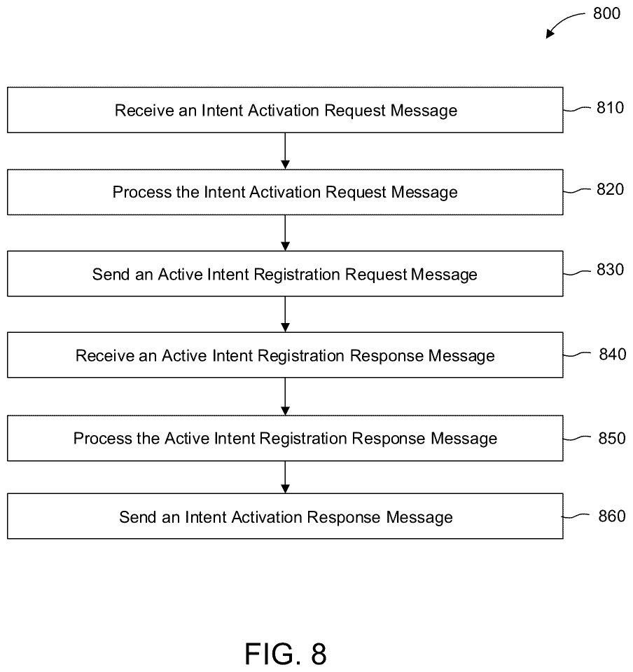

FIG. 8 shows an example procedure for enabling traceability for a layered intent framework architecture by a network node with IMF capabilities.

A network node with IMF capabilities (e.g., a CN network function or IMF anchor) may receive a message (e.g., request message) to activate an intent (e.g., an intent activation request message) 810. The intent activation request message may include intent information. The intent information may include, for example, an intent identifier, an intent semantic description, intent configuration parameters and/or intent management parameters. Intent configuration parameters may define the configuration parameters that are associated with an intent. For example, considering the intent “Establish an XR session with a minimum QoS of X at the edge”, it may be necessary to provide an application identifier and/or service identifier for establishing the XR session, to provide WTRU identifiers to identify a subscribed edge computing service provider and to provide a QoS value. Each intent, dependent on its objectives, may have a different list of configuration parameters. Intent management parameters may provide information about the intent lifecycle. For example, the management parameters may indicate that an intent should be activated only in a certain location, at a certain time of day or for a certain period. The management parameters may also include notification information (e.g., uniform resource locator (URL), uniform resource identifier (URI), Internet Protocol (IP) address, port) for reporting events associated with an intent. The intent activation request message may include requestor information. The information about the requestor may include, for example, a requestor identifier (e.g., a GPSI, an NF identifier or an AF identifier) and/or security credentials of the requestor. The IMF may use the intent information to determine the actions to take to realize the intent objective and may use the requestor information to authorize the intent activation or to provide traceability about the intent. The intent activation request message may include traceability configuration information and/or a traceability configuration identifier that provides configuration information associated with the intent to be activated. The IMF may use the provided information to configure traceability of the activated intent. The intent activation request message may be received from an intent consumer (e.g., WTRU/NF/AF).

The network node may process the intent activation request message 820. The network node may authorize the intent activation request. The network node may translate the intent activation request information into a list of one or more actions (e.g., active intent). For example, considering the intent “Establish an XR session with a minimum QoS of X at the edge”, the list of actions may include interacting with several subsystems such as the edge subsystem for discovering the Edge Application Server (EAS), with the management system to instantiate the EAS and with the CN for configuring the minimum QoS for the provided EAS. Each intent, dependent on its objectives, may have a different list of actions. The network node may assign or associate an identifier to the active intent to identify an intent instance (e.g., Intent Instance Identifier (II-ID)). The network node may maintain an association between one or more requests, one or more related II-ID and one or more associated events. The network node may be configured to initiate a lifecycle for the intent. The lifecycle of an intent may start when an intent is first activated. The lifecycle of an intent may end when the processing associated with an active intent is completed. It may be appreciated that an intent lifecycle duration may be associated with a predetermined duration and/or with a duration for processing of one or more commands (e.g., execution of task(s), API call(s), intent(s)) and/or with the duration for the lifecycle of a communication session (e.g., from connection establishment to connection termination) and/or with the duration of a process (e.g., from the instantiation of a process/application / server until the termination of the process/application/server) and/or with the duration for which a user or a WTRU is present in a determined location and/or area and/or with the duration for which a WTRU is connected to/with a network / access point/radio access technology. The IMF may consider the Intent management parameters (e.g., intent lifecycle information) to determine the intent lifecycle. In other words, the IMF may determine when to initiate and when to terminate the activation of an intent. The determination of an intent activation and/or termination may result in the IMF providing traceability information for the intent activation and/or termination to the UDM/UDR and/or informing the intent requestor about intent activation and/or termination events. It may be appreciated that an IMF may determine an intent lifecycle duration based on an intent management parameter and/or a predetermined duration and/or a duration for processing of one or more commands (e.g., execution of task(s), API call(s), intent(s)) and/or a duration for the lifecycle of a communication session (e.g., from connection establishment to connection termination) and/or a duration of a process (e.g., from the instantiation of a process/application/server until the termination of the process/application/server) and/or a duration for which a user or a WTRU is present in a determined location or area and/or a duration for which a WTRU is connected to/with a network/access point/radio access technology.

The network node may send a message (e.g., request message) to register an active intent for traceability (e.g., active intent registration request message) 830. The active intent registration request message may include an IMF identifier, the assigned or associated II-ID, the intent information, and/or the intent requestor information. The request message may be sent to a UDM/UDR.

The network node may receive a message (e.g., response message) indicating a registration of the active intent for traceability (e. g, active intent registration response message) 840. The active intent registration response message may include an identifier that uniquely identifies a root active intent and that may be used by the UDM/UDR to provide traceability on subsystem intents and/or API invocations that may have been triggered by the root active intent across network subsystems (e.g., a Traceability Correlation Identifier (TC-ID)).

The network node may process the active intent registration response message 850. The network node may associate the II-ID with the TC-ID. The TC-ID may be provide by the UDM/UDR. This association may allow the IMF to obtain the TC-ID when managing the active intent.

The network node may send a message (e.g., intent activation response message) based on the determined list of actions 860. The intent activation response message may include the TC-ID. The TC-ID may be assigned by the UDM/UDR. The intent activation response message may include the II-ID assigned to the activated intent by the IMF. The intent activation response message may include intent response information. For example, considering the intent “Establish an XR session with a minimum QoS of X at the edge”, the intent response information may include information about the requested EAS (e.g., EAS identifier, EAS endpoint, EAS capabilities) and an indication of whether the requested QoS can be provided. For example, considering the intent “generate a traceability report for intent-X”, the intent response information may include a traceability report for intent-X. Each intent, dependent on its objectives, may have a different intent response information. The II-ID may be used by the intent consumer in interactions (e.g., receiving or sending messages) with the IMF, for example, to send intent management messages to the IMF or to associate received messages from the IMF with the activated intent. The intent consumer may use the TC-ID to provide traceability information to the system, for example, to provide QoE traceability information associated with an active intent. The intent activation response message may be sent to the intent consumer. The intent activation response message may be sent to an IMF, an NF, an API and/or a subsystem.

The network node may receive a message (e.g., one or more messages) associated with an active intent. The message may include an indication that an action associated with an active intent has been completed. The message may include an indication that an event associated with an active intent has been detected. The message may include an indication of a QoE associated with an active intent. The message may be received from a of a WTRU, an IMF, a UDM/UDR, an NF, and/or a subsystem.

The network node may send a message to update an active intent (e.g., active intent update request message). The message may include a TC-ID, an II-ID, a completed action, an event detection, and/or a QoE. The message may be sent to a UDM/UDR. The network node may receive, from the UDM/UDR, a message that includes an indication that the active intent has been updated.

The network node may send a message to indicate that an active intent has been updated (e.g., active intent update response message). The active intent update response message may include a TC-ID, an II-ID, an indication that an intent has been activated and may include information related to the completion of an intent. The message may be sent to an intent consumer (e.g., WTRU/NF/AF).

The network node may receive a message to retrieve a traceability report associated with an active intent. This message may include a TC-ID and/or II-ID and/or report filters. This message may be received from a report consumer (e.g., WTRU/NF/AF).

The network node may send a message to retrieve a traceability report. This message may include a TC-ID and/or report filters. This message may be sent to a UDM/UDR.

The network node may receive a message indicating a traceability report. This message may include a traceability report associated with a TC-ID. This message may be received from an UDM/UDR.

The network node may send a message indicating a traceability report. This message may include a traceability report associated with an active intent. This message may be send to a report consumer (e.g., WTRU/NF/AF).

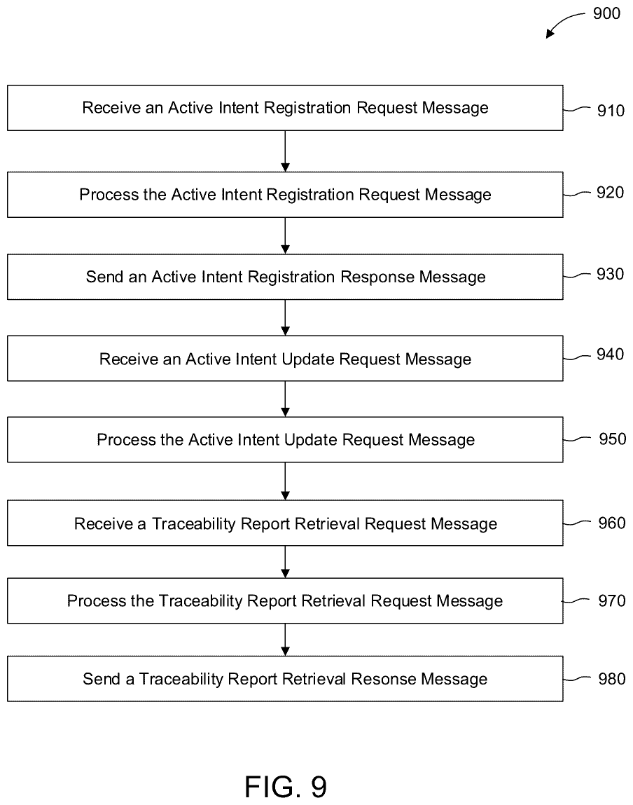

FIG. 9 shows an example procedure for enabling traceability for a layered intent framework architecture by a UDM/UDR.

A UDM/UDR may receive a message to register an active intent (e.g., active intent registration request) 910. The active intent registration request may be a request to create an active intent entry. The active intent registration request message may include an IMF identifier (IMF-ID), an Intent Instance identifier (II-ID) (e.g., an assigned II-ID), information about an intent and/or information about an intent requestor. The active intent entry may be used to manage traceability information of an intent when it is processed in a layered system. The active intent registration request message may be received from an IMF (e.g., network node with IMF capabilities). The active intent registration request message may include traceability configuration information and/or a traceability configuration identifier that provides configuration information associated with the active intent. The UDM/UDR may use the provided information to configure traceability of the activated intent. For example, the traceability information may be provided to the UDM/UDR, and the UDM/UDR may consider the traceability configuration to determine if the traceability information should be collected.

The UDM/UDR may process the active intent registration request 920. The UDM/UDR may authorize the active intent registration request. The UDM/UDR may assign a Traceability Correlation Identifier (TC-ID) to the active intent. The UDM/UDR may create a traceability entry for the active intent traceability. The TC-ID may be an identifier that uniquely identifies a root active intent and that may be used by the UDM/UDR to provide traceability on subsystem intents and/or API invocations that may have been triggered by the root active intent across network subsystems. The TC-ID may differ from the II-ID. For example, when a root active intent which is assigned a first II-ID and triggers the execution of multiple subsystem intents which have their own respective II-IDs, it is necessary to have a unique identifier (e.g., the TC-ID) to correlate that the multiple intents (e.g., multiple II-IDs) are associated to a root intent. An intent activation may result in activating multiple intents where each intent has its own II-ID and where all activated intent shares the same TC-ID. Upon creating an active intent entry in the UDR, the UDM may associate the TC-ID with the information received in the request, including the II-ID, the IMF-ID, the intent information, and the requestor information.

The UDM/UDR may send a message indicating a registered active intent (e.g., active intent registration response) 930. The active intent registration response message may include an indication that the active intent entry has been created. The active intent registration response message may include an indication of an active intent and a TC-ID. The message may be sent to the IMF.

The UDM/UDR may receive a message to update an active intent (e.g., active intent update request) 940. The active intent update request may be a request for providing traceability information about the activation of an intent. The active intent update request message may include a TC-ID, an II-ID and an action list information. The action list information may include details of the actions taken as part of the activation of an intent. The active intent update request message may be received from an IMF, a WTRU, an NF, an AF and/or a subsystem. The active intent update request message may be received via a network exposure function (NEF).

The UDM/UDR may process the active intent update request 950. The UDM/UDR may update the active intent entry associated with the TC-ID with traceability information. The UDM/UDR may store the information provided in the active intent update request message in the active intent entry.

The UDM/UDR may receive a message to retrieve a traceability report (e.g., traceability report retrieval request) 960. The traceability report retrieval request message may include a TC-ID and report filters. The traceability report retrieval request message may be received from an IMF, a WTRU, an NF, and/or an AF. The traceability report retrieval request message may be received via a NEF.

The UDM/UDR may process the traceability report retrieval request 970. The UDM/UDR may retrieve the traceability entries associated with the TC-ID. The UDM/UDR may generate a traceability report considering the report filters.

The UDM/UDR may send a message indicating a traceability report (e.g., traceability report retrieval response) 980. The traceability report retrieval response message may include a traceability report associated with the TC-ID. The traceability report retrieval response message may be sent to an IMF, a WTRU, an NF, and/or an AF. The traceability report retrieval response message may be sent via a NEF.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a network node having intent management function (IMF) capability, the method
comprising:
receiving a first message, wherein the first message is a request to activate an intent, wherein the first message comprises intent information;
determining a list of actions based on the intent information from the first message;
assigning an intent instance identification to the intent;
initiating a lifecycle for the intent;
sending a second message to register the intent;
receiving a third message indicating registration of the intent, wherein the third message comprises a traceability correlation identifier;
associating the intent instance identification with the traceability correlation identifier; and
sending a fourth message, based on the determined list of actions, wherein the fourth message includes the traceability correlation identifier.

2. The method of claim 1, wherein the intent information comprises at least one of: an intent identifier, an intent semantic description, intent configuration parameters, intent management parameters, or intent requestor information.

3. The method of claim 2, wherein the intent management parameters include information regarding the lifecycle for the intent and wherein the requestor information comprises an intent requestor identification and requestor security credentials.

4. The method of claim 1, wherein the first message is received from an intent consumer, wherein the intent consumer is at least one of: a wireless transmit/receive unit (WTRU), a network function (NF), or an application function (AF); wherein the second message is sent to a unified data management (function) (UDM) / unified data registry (UDR); wherein the third message is received from the UDM/UDR; and wherein the fourth message is sent to the intent consumer.

5. The method of claim 1, wherein the list of actions comprise actions for realizing an objective of the intent.

6. The method of claim 1, wherein the second message comprises at least one of: an IMF identifier, the assigned intent instance identification, the intent information, or intent requestor information.

7. The method of claim 1, further comprising:
receiving a message associated with the intent, wherein the message associated with the intent comprises at least one of: an indication that an action associated with the intent is complete, an indication that an event associated with the intent has been detected, or an indication of a quality of experience (QoE) associated with the intent, wherein the QoE is used to correlate a user experience with the lifecycle of the intent.

8. The method of claim 1, further comprising:
sending a message to update the intent, wherein the message to update the intent comprises at least one of: the traceability correlation identifier, the intent instance identification, a completed action, an event detection, or a quality of experience (QoE);
receiving a message indicating that the intent is updated; and
sending a message indicating that the intent is updated comprising at least the traceability correlation identifier and the intent instance identification.

9. The method of claim 1, further comprising:
receiving a message requesting a traceability report associated with the intent comprising the traceability correlation identifier, the intent instance identification, and report filters;
sending a message requesting retrieval of the traceability report comprising the traceability correlation identifier, the intent instance identification, and report filters;
receiving a traceability report; and
sending the traceability report.

10. The method of claim 1, wherein the determining a list of actions based on the intent information from the first message is based on artificial intelligence/machine learning (AI/ML).

11. A network node having intent management function (IMF) capability comprising:
a receiver;
a transmitter; and
a processor, wherein:
the receiver is configured to receive a first message, wherein the first message is a request to activate an intent, wherein the first message comprises intent information;
the processor is configured to determine a list of actions based on the intent information from the first message;
the processor is further configured to assign an intent instance identification to the intent;
the processor is further configured to initiate a lifecycle for the intent;
the transmitter is configured to send a second message to register the intent;
the receiver is further configured to receive a third message indicating registration of the intent, wherein the third message comprises a traceability correlation identifier;
the processor is further configured to associate the intent instance identification with the traceability correlation identifier; and
the transmitter is further configured to send a fourth message, based on the determined list of actions, wherein the fourth message includes the traceability correlation identifier.

12. The network node of claim 11, wherein the intent information comprises at least one of: an intent identifier, an intent semantic description, intent configuration parameters, intent management parameters, or intent requestor information.

13. The network node of claim 12, wherein the intent management parameters include information regarding the lifecycle for the intent and wherein the requestor information comprises an intent requestor identification and requestor security credentials.

14. The network node of claim 11, wherein the first message is received from an intent consumer, wherein the intent consumer is at least one of: a wireless transmit/receive unit (WTRU), a network function (NF), or an application function (AF); wherein the second message is sent to a unified data management (function) (UDM) / unified data registry (UDR); wherein the third message is received from the UDM/UDR; and wherein the fourth message is sent to the intent consumer.

15. The network node of claim 11, wherein the list of actions comprise actions for realizing an objective of the intent.

16. The network node of claim 11, wherein the second message comprises at least one of: an IMF identifier, the assigned intent instance identification, the intent information, or intent requestor information.

17. The network node of claim 11, wherein:
the receiver is further configured to receive a message associated with the intent, wherein the message associated with the intent comprises at least one of: an indication that an action associated with the intent is complete, an indication that an event associated with the intent has been detected, or an indication of a quality of experience (QoE) associated with the intent, wherein the QoE is used to correlate a user experience with the lifecycle of the intent.

18. The network node of claim 11, wherein:
the transmitter is further configured to send a message to update the intent, wherein the message to update the intent comprises at least one of: the traceability correlation identifier, the intent instance identification, a completed action, an event detection, or a quality of experience (QoE);
the receiver is further configured to receive a message indicating that the intent is updated; and
the transmitter is further configured to send a message indicating that the intent is updated comprising at least the traceability correlation identifier and the intent instance identification.

19. The network node of claim 11, wherein:
the receiver is further configured to receive a message requesting a traceability report associated with the intent comprising the traceability correlation identifier, the intent instance identification, and report filters;
the transmitter is further configured to send a message requesting retrieval of the traceability report comprising the traceability correlation identifier, the intent instance identification, and report filters;
the receiver is further configured to receive a traceability report; and
the transmitter is further configured to send the traceability report.

20. The network node of claim 11, wherein the list of actions is determined based on artificial intelligence / machine learning (AI/ML).
